(19) United States
(12) Patent Application Publication
(10) Pub. No.: US 2026/0088671 A1
(43) Pub. Date: Mar. 26, 2026

(54) AN ELECTRIC MOTOR FOR MARINE PROPULSION

(71) Applicant: VOLVO PENTA CORPORATION, Göteborg (SE)

(72) Inventors: Lars WIK, Sävedalen (SE); Johan TELL, Göteborg (SE)

(73) Assignee: VOLVO PENTA CORPORATION, Göteborg (SE)

(21) Appl. No.: 19/109,329

(22) PCT Filed: Sep. 8, 2022
(86) PCT No.: PCT/EP2022/075045

§ 371 Date: Mar. 6, 2025

(51) Int. Cl. H02K 1/2791; H02K 1/12; H02K 1/32; H02K 7/08

(52) U.S. Cl. CPC H02K 1/2791; H02K 1/12; H02K 1/32; H02K 7/083; H02K 2201/15; H02K 2203/03

(57) ABSTRACT

An electric machine for a marine vessel has a motor axle extending along a central axis of the electric machine. The motor axle has a first end and a second end, where the first end is arranged to drive a propeller of the marine vessel. An elongated rotationally symmetric hollow rotor is fixedly attached to the motor axle and radially external to the motor axle, such that a volume is formed between the motor axle and the hollow rotor. The electric machine further comprising an elongated rotationally symmetric hollow stator at least partly received in the volume formed between the motor axle and the hollow rotor. The motor axle and the hollow rotor comprise a plurality of permanent magnets arranged facing the inside and the outside of the hollow stator, respectively, and where the hollow stator comprises a plurality of coils arranged to be electrically connected to an external control unit, where each coil is arranged to generate a respective magnetic flux in the radial direction.

### TECHNICAL FIELD

The present disclosure relates to drivelines for marine vessels, in particular electric machines and electrically powered drivelines.

### BACKGROUND

Electrically powered drivelines for marine propulsion are becoming increasingly common, mainly due to the recent technical progress in electric machines and associated advances in high capacity battery systems.

Space on-board marine leisure craft such as sailboats and smaller motor vessels is often scarce, and many systems compete for the available space. Hence, there is a desire for spatially efficient powertrains for use in marine applications.

### SUMMARY

It is an objective of the present disclosure to provide electric machines with form factors suitable for use in marine applications. This objective is at least in part obtained by an electric machine for a marine vessel. The machine comprises a motor axle extending along a central axis of the electric machine. The motor axle has a first end and a second end, where the first end is arranged to drive a propeller of the marine vessel, at least indirectly. An elongated rotationally symmetric hollow rotor is fixedly attached to the motor axle and radially external to the motor axle, such that a volume is formed between the motor axle and the hollow rotor. The electric machine also comprises an elongated rotationally symmetric hollow stator at least partly received in the volume formed between the motor axle and the hollow rotor. Both the motor axle and the hollow rotor comprise a plurality of permanent magnets arranged facing the inside and the outside of the hollow stator, respectively, and the hollow stator comprises a plurality of coils arranged to be electrically connected to an external control unit, where each coil is arranged to generate a respective magnetic flux in the radial direction. This way a high efficiency radial flux electric machine can be obtained at low cost. The motor resembles the type of “pancake style” or axial flux electric motor which have recently become popular, but in a radial flux version. Just as for a PCB-based pancake motor, the hollow stator can be formed in a PCB material, such as laminated composite made from non-conductive substrate materials, of which the well-known FR-4 material is an example. The coils on the stator can be printed or etched directly onto the PCB material, which allows for cost-efficient production of the motor.

The coils may in some cases be axially offset from at least some of the permanent magnets. This offset in the axial direction means that a force directed along the center axis will be generated, which at least partly counteracts the pushing or pulling force generated by the propeller. Hence, the load on axle bearings can be reduced, and at least some of the force absorbed by the stator via the coils.

Various geometries and form factors can be achieved using the herein disclosed techniques. The elongated rotationally symmetric hollow stator and the elongated rotationally symmetric hollow rotor can be of cylindrical shape, frustoconical shape or prolate spheroidal shape, just to give a few examples.

According to some aspects, a first end of the elongated hollow rotor is attached to the motor axle first end and the elongated hollow rotor is open at a second end opposite to the first end to receive the elongated hollow stator. The hollow rotor and the motor axle can be integrally formed in one single piece of material or formed separately from each other and attached together after the magnets have been mounted.

The electric machine may also comprise a housing arranged to hold a coolant, which housing can also serve as support for the rotor parts, e.g., by one or more motor axle bearings at the first end and/or at the second end of the motor axle.

A cooling circuit optionally extends through the motor axle. This cooling circuit comprises at least one aperture that opens up into the volume formed between the motor axle and the hollow rotor, thereby allowing efficient cooling by transporting heat away from the motor components in use.

Extensions of the concept are also possible, where the electric machine comprises a plurality of elongated rotationally symmetric hollow rotors fixedly attached to the motor axle and located in sequence radially external to the motor axle, where each hollow rotor comprises an internal surface that delimits a respective volume. In this case the machine further comprises a plurality of elongated rotationally symmetric hollow stators at least partly received in the volumes defined by the elongated rotationally symmetric hollow rotors, where each stator supports coils arranged to generate radial flux and where each rotor comprises permanent magnets arranged to cooperate with the coils.

According to other aspects, the motor axle extends axially through the electric machine. The first end of the motor axle can then be arranged to drive a propeller, while the second end of the motor axle can be arranged to drive a coolant pump for circulating coolant through the electric machine. This way a spatially efficient cooling system for the electric motor and/or for other components of the driveline can be obtained.

Marine vessels and drive units associated with the above discussed advantages are also discussed herein.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The above, as well as additional objects, features and advantages, will be better understood through the following illustrative and non-limiting detailed description of exemplary embodiments, wherein:

FIG. 1 illustrates an example marine vessel;

FIG. 2 shows an example of an electric machine;

FIGS. 3A-B illustrate details of example electric machines;

FIGS. 4-5 illustrate example electric machines; and

FIGS. 6-7 illustrate an electric drive unit with integrated cooling.

### DETAILED DESCRIPTION

The present disclosure will now be described more fully hereinafter with reference to the accompanying drawings, in which exemplary embodiments are shown. The disclosure may, however, be embodied in many different forms and should not be construed as limited to the embodiments set forth herein; rather, these embodiments are provided for thoroughness and completeness. Like reference character refer to like elements throughout the description.

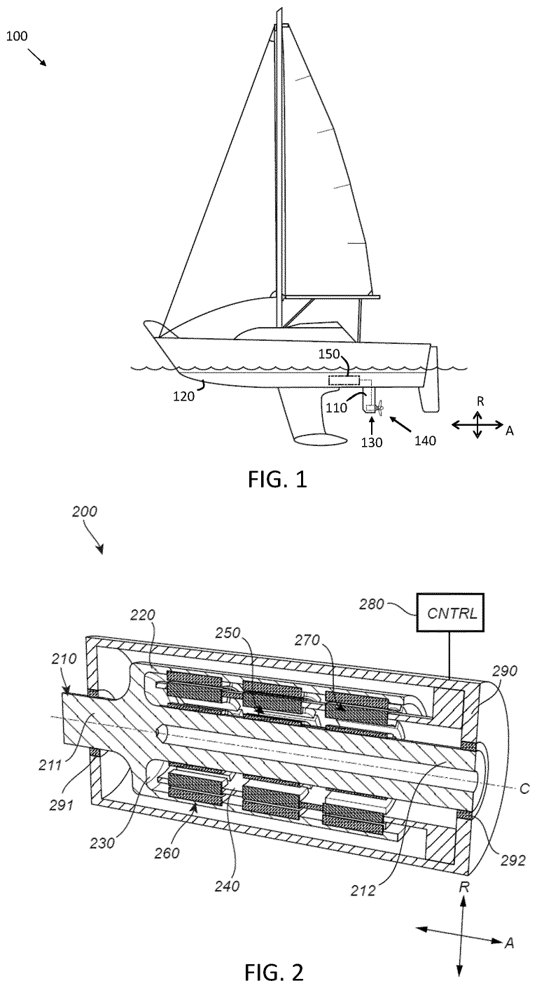

FIG. 1 illustrates an example marine vessel 100, in this case a sailing boat. The vessel comprises a drive unit 110 attached to the hull 120 of the boat. The drive unit 110 supports an electric machine 130 which drives a propeller 140. The electric machine 130 draws electrical power from a battery pack 150.

The electric machine in the example is integrated in the drive unit 110. It is, however, appreciated that the electric machine can be arranged outside of the drive unit 110, e.g., next to the battery 150. A straight horizontal axle design is also possible, i.e., one which does not use a drive unit 110 extending down into the water.

The electric machines discussed herein can also be advantageously used in drive units for other types of marine vessels, such as smaller power boats and the like. The disclosure is in no way limited to electric drive for sailboats, although this may be a particularly suitable application. The electric machine can, for instance, be used for electric stern drive in power boats, and also for hybrid electric drivetrains.

The electric machine 130 is in this example integrated in the lower part of the drive unit, i.e., submerged under the hull 120. This location is associated with rather strict constraints on the volume and form factor of the electric machine. The underwater body of the drive unit cannot be made too large, since this would have a negative effect on the drag and overall power efficiency of the vessel 100. A cylindrical or conically shaped electric machine 130 mounted in this location, where the motor axle is aligned with the propeller axle will have particularly strict constraints on its radial dimensions R, i.e., the cross-section area of the electric machine seen from the travelling direction of the vessel. The spatial constraints in axial direction A are more relaxed since the axial direction is aligned with the flow of water when the boat 100 travels through the water. Hence, an electric machine which is elongated in its axial direction A, and which has a limited extension in the radial direction R, is desired.

FIG. 2 illustrates an electric machine 200 which has the desired elongated form factor, i.e., its extension in the axial direction A substantially exceeds its extension in radial direction R perpendicular to the axial direction, making it suitable for integration in submerged electrical pod-drives and the like. The electric machine 200 illustrated in FIG. 2 is of cylindrical shape, but frustoconical and prolate spheroid shaped designs are also possible. A motor axle 210 extends along a central axis C of the electric machine. The motor axle has a first end 211 and a second end 212, where the first end is arranged to drive a propeller 140 of the marine vessel 100 possibly via some form of transmission. In other words, the propeller (or propellers in case of a duo-prop system) may be directly attached to the motor axle or via some form of transmission. A direct drive without gear ratio is of course advantageous due to the low inherent complexity, but it may also be desirable to reduce the motor axle speed by some form of transmission, since high speed electric motors more easily generate high power compared to electric motors operating at lower speeds, and most propellers work better at lower speeds.

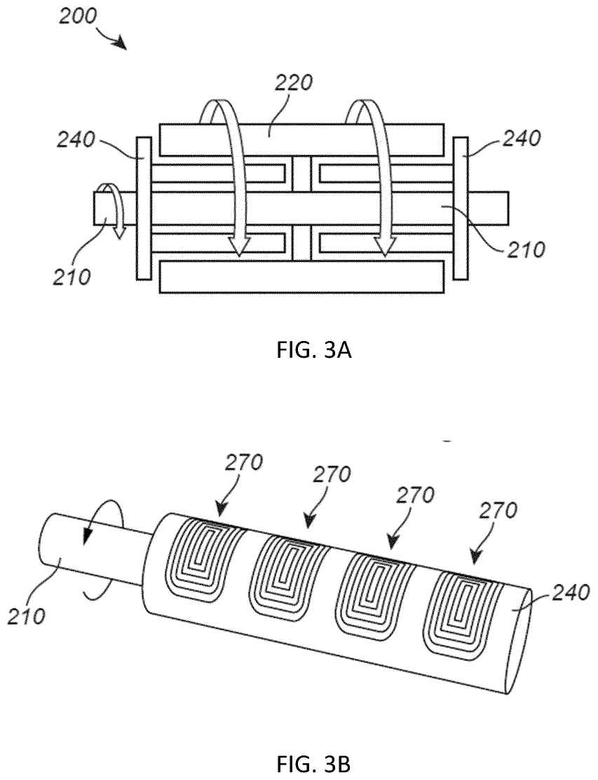

An elongated rotationally symmetric hollow rotor 220 is fixedly attached to the motor axle 210 and located radially external to the motor axle 210 as shown in FIG. 3. The hollow rotor 220 in FIG. 2 may be integrally formed together with the propeller axle to form a “cup-like” shape with the propeller axle in its center, which is closed at one end and open at the other end, such that a volume 230 is formed between the motor axle 210 and the hollow rotor 220. An elongated rotationally symmetric hollow stator 240 can then be at least partly received in the volume 230 formed between the motor axle 210 and the hollow rotor 220. The stator has a shape matched to that of the combination of motor axle and hollow rotor, such that it fits into the rotationally symmetric slot formed in-between the motor axle and the hollow rotor. This means that the motor axle and hollow rotor combination can rotate freely with the stator received statically there in between.

The motor axle 210 and the elongated rotationally symmetric hollow rotor 220 can be integrally formed. However, production of the motor may be simplified if the motor axle 210 and the elongated rotationally symmetric hollow rotor 220 are formed separately, such that the permanent magnets can be attached before they are assembled to form the complete rotor.

Put differently, the electric machine 200 comprises a motor axle 210 and two cup-like members. The first cup-like member 220 is fixedly attached to the motor axle 210 to form a slot between the outside of the motor axle and the inside of the first cylinder. The second cup-like member fits into this slot, and when inserted it has an outside which faces the inside of the first cup-like member and an inside which faces the motor axle.

The motor axle 210 and the hollow rotor 220 comprise a plurality of permanent magnets 250, 260 arranged facing the inside and the outside of the hollow stator 240, respectively, and the hollow stator 240 comprises a plurality of coils 270 arranged to be electrically connected to an external control unit 280, where each coil is arranged to generate a respective magnetic flux in the radial direction R. Thus, by configuring, e.g., an inverter of the control unit 280 to generate a time-variant radial magnetic flux in a known manner, a torque can be generated to bring the motor axle into rotation. This way a powerful electric machine is obtained which has the desired form factor.

The hollow stator 240 is preferably formed in a printed circuit board (PCB) material, i.e., some form of glass reinforced epoxy laminate such as FR-4 or the like. Using a PCB-based stator in this manner is advantageous since the coils 270 can be printed or etched onto the PCB material in a low-cost manner. The elongated hollow stator 240 may also comprise power electronics arranged to generate the electrical current through the coils 270. Thus, the stator which carries a significant part of the complexity of the electric machine can be manufactured efficiently as an integrated unit which is then assembled with the motor axle unit.

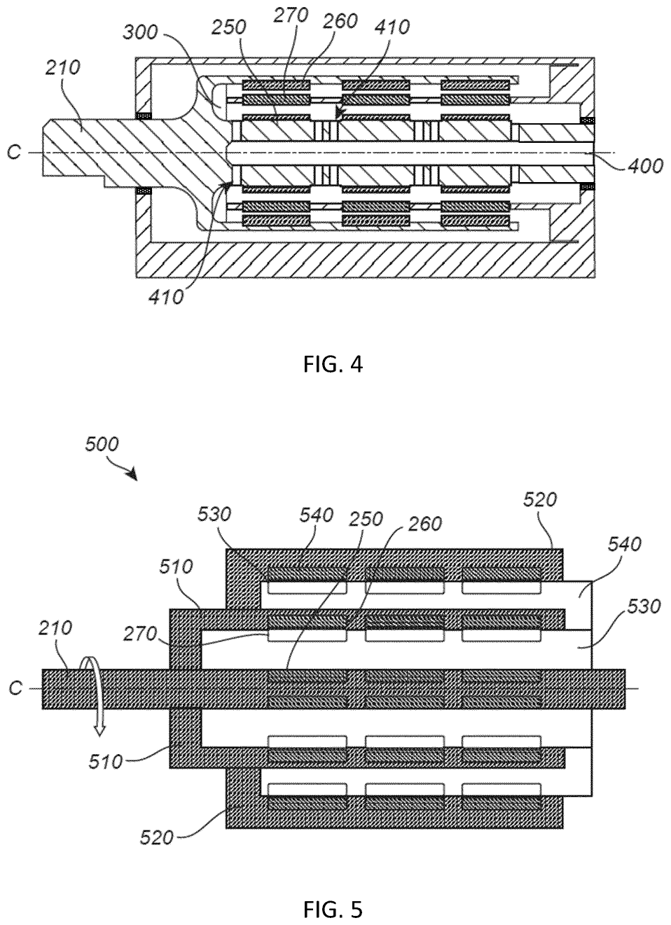

The elongated hollow stator 240 optionally supports a motor axle bearing at the second end 212 of the motor axle 210, as exemplified in FIG. 2. This makes for a particularly robust design. Alternatively, or as a complement, the motor axle 210 can be supported by axle bearings 291, 292, such as radial needle bearings, supported by a motor housing 290 which encloses both the rotor and the stator of the electric machine. This housing may also advantageously be configured to hold a coolant for transporting heat away from the electric machine. Some examples of cooling circuits will be discussed below in connection to FIGS. 4, 6 and 7.

In FIG. 2, a first end of the elongated hollow rotor 220 is attached to the motor axle first end 211 and the elongated hollow rotor 220 is open at a second end opposite to the first end to receive the elongated hollow stator 240, which enables insertion of the stator from the open end of the hollow rotor. This is, however, not the only way in which an electric machine according to the present teaching can be realized. FIG. 3A shows an alternative, where the elongated hollow rotor 220 is instead attached at a middle portion of the motor axle 210, which allows a first and a second elongated hollow stator to be inserted into the two volumes formed by the motor axle and the hollow rotor. The motor axle can then be supported by the stators on either end, which is an advantage.

FIG. 3B illustrates details of a hollow stator 240 which at least partly encloses a motor axle 210, where example coils 270 have been formed on the stator by, e.g., printing or etching into a PCB material. As mentioned above, the coils are set up to generate radial flux, making the electric machine a radial flux machine.

The permanent magnets attached to the motor axle 210 and to the hollow rotor part 220 are of opposite polarity in order to generate the motor axle torque in response to the flu. By arranging permanent magnets on both sides of the coil structure a more efficient electric machine is obtained. The polarity and general orientation of the permanent magnets is done in dependence of the coil flux generated by the control unit 280.

The electric machine 200, in use, will be subject to axial pressure from the propeller, at least of the propeller is directly attached to the propeller axle. To compensate for this axial pressure at least partly from the propeller, the permanent magnets can optionally be arranged axially offset from the permanent magnets, possibly in a helical pattern. This axial offset generates an electromagnetic force on the motor axle in the axial direction, i.e., pushes the motor axle in the axial direction, and therefore counteracts the axial pressure from the propeller, which reduces the strain on bearing and the like which otherwise must absorb the axial force.

The elongated rotationally symmetric hollow stator 240 and the elongated rotationally symmetric hollow rotor 220 are preferably of cylindrical shape as illustrated in, e.g., FIG. 2. However, other rotationally symmetric shapes are also possible. The elongated rotationally symmetric hollow stator 240 and the elongated rotationally symmetric hollow rotor 220 may for instance have matching frustoconical shapes or matching prolate frustospherical shapes (i.e., an American football shape or prolate spherical shape where the pointy ends have been removed).

FIG. 4 illustrates an example electric machine 200 where a cooling circuit 400 extends through a part of the motor axle 210. The cooling circuit 400 comprises at least one aperture 410 that opens up into the volume 230 formed between the motor axle 210 and the hollow rotor 220. The inlet to the cooling circuit 400 is here formed in the stator. Coolant may, for instance, enter the electric machine 200 via the aperture in the side wall of the stator, pass through the conduit formed in the motor axle, and out through the apertures 410. After the apertures 410 the coolant contacts the coils of the stator, and then also contacts the hollow rotor part.

FIG. 5 shows an example where a plurality of hollow rotors has been used in combination with a matching plurality of hollow stators. The plurality of elongated rotationally symmetric hollow rotors 510, 520 are fixedly attached to the motor axle 210 and located in sequence radially external to the motor axle 210. Each hollow rotor comprises an internal surface that delimits a respective volume. The machine 500 further comprises a plurality of elongated rotationally symmetric hollow stators 530, 540 at least partly received in the volumes defined by the elongated rotationally symmetric hollow rotors 510, 520. Each of the hollow stators comprises coils arranged to generate radial flux and each of the hollow rotors comprises permanent magnets arranged to cooperate with the coils to generate torque by the electric machine. This design may benefit from stabilization by one or more radial needle bearings that bear on the rotor parts.

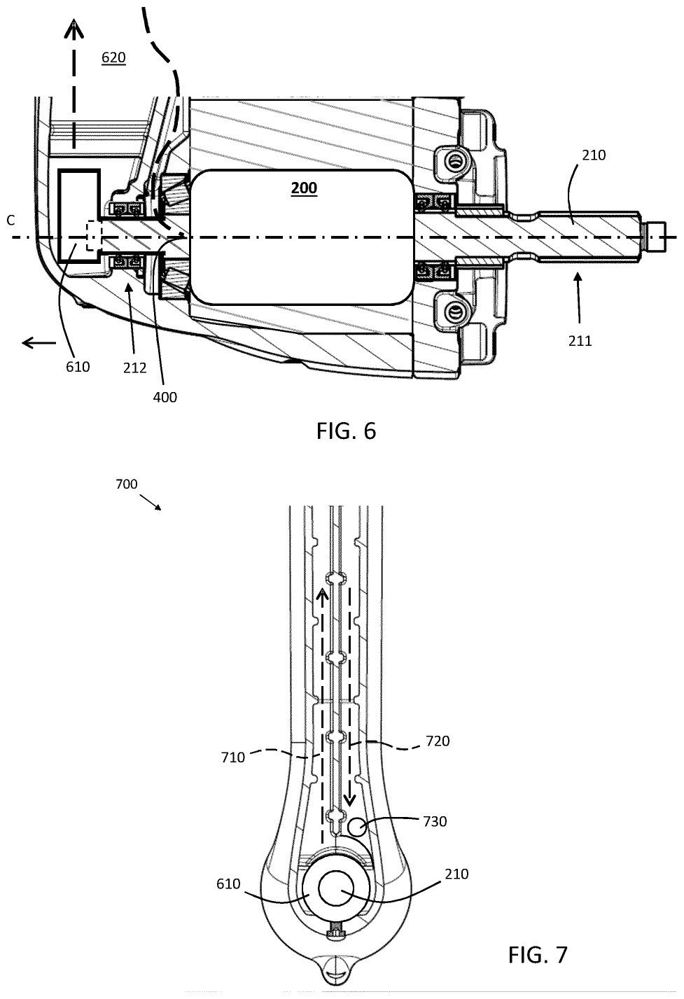

FIG. 6 illustrates as example application of the herein described electric machine. In this case the motor axle 210 extends axially through the electric machine and protrudes on both sides of the motor housing. The first end 211 of the motor axle is arranged to directly drive a propeller (not shown in FIG. 6) and the second end 212 of the motor axle 210 is arranged to drive a coolant pump 610 for circulating coolant 620 through the electric machine 130, 200, 500, and potentially also other components on the vessel 100 in need of cooling, such as the battery system 150. The coolant pump may, for instance be realized as a centrifugal pump which forces coolant up 710 into a drive unit 700, as illustrated in FIG. 7. More than one coolant pump can be driven in this manner, which allows more than one type of coolant to be circulated in the drive system. The coolant then exchanges heat with the surrounding seawater through the body of the drive unit before flowing back down 720 through the drive unit 700 and into the electric machine, e.g., via an aperture 730. This aperture 730 may, e.g., be fluidly connected to the cooling circuit 400 of the example electric machine discussed in connection to FIG. 4 above.

1. An electric machine for a marine vessel, comprising
a motor axle extending along a central axis of the electric machine, the motor axle having a first end and a second end, where the first end is arranged to drive a propeller of the marine vessel,
where an elongated rotationally symmetric hollow rotor is fixedly attached to the motor axle and radially external to the motor axle, such that a volume is formed between the motor axle and the hollow rotor,
the electric machine further comprising an elongated rotationally symmetric hollow stator formed in a printed circuit board, PCB material, at least partly received in the volume formed between the motor axle and the hollow rotor,
where the motor axle and the hollow rotor comprise a plurality of permanent magnets arranged facing the inside and the outside of the hollow stator, respectively,
where the hollow stator comprises a plurality of coils printed or etched on the PCB material arranged to be electrically connected to an external control unit, where each coil is arranged to generate a respective magnetic flux in the radial direction, and
wherein the electric machine's extension in an axial direction substantially exceeds its extension in radial direction perpendicular to the axial direction.

2. (canceled)

3. (canceled)

4. The electric machine according to claim 1, where the coils are axially offset from at least some of the permanent magnets.

5. The electric machine according to claim 1, where the elongated rotationally symmetric hollow stator and the elongated rotationally symmetric hollow rotor are of cylindrical shape.

6. The electric machine according to claim 1, where the elongated rotationally symmetric hollow stator and the elongated rotationally symmetric hollow rotor are of frustoconical shapes or of prolate spheroidal shapes.

7. The electric machine according to claim 1, where a first end of the elongated hollow rotor is attached to the motor axle first end, where the elongated hollow rotor is open at a second end opposite to the first end to receive the elongated hollow stator.

8. The electric machine according to claim 1, where the electric machine comprises a housing arranged to hold a coolant.

9. The electric machine according to claim 8, where the housing supports one or more motor axle bearings at the first end and/or at the second end of the motor axle.

10. (canceled)

11. The electric machine according to claim 1, where a cooling circuit extends through the motor axle, the cooling circuit comprising at least one aperture that opens up into the volume formed between the motor axle and the hollow rotor.

12. The electric machine according to claim 1, comprising a plurality of elongated rotationally symmetric hollow rotors fixedly attached to the motor axle and located in sequence radially external to the motor axle, where each hollow rotor comprises an internal surface that delimits a respective volume, the machine further comprising a plurality of elongated rotationally symmetric hollow stators at least partly received in the volumes defined by the elongated rotationally symmetric hollow rotors, where each stator comprises coils arranged to generate radial flux and where each rotor comprises permanent magnets arranged to cooperate with the coils.

13. The electric machine according to claim 1, where the motor axle extends axially through the electric machine, where the first end of the motor axle is arranged to drive a propeller and where the second end of the motor axle is arranged to drive a coolant pump for circulating coolant through the electric machine.

14. A drive unit comprising an electric machine according to claim 1, where the electric machine is arranged to be submerged under the hull of the vessel during operation.

15. A marine vessel comprising one or more electric machines according to claim 1.
